(19) United States
(12) Patent Application Publication
(10) Pub. No.: US 2003/0074572 A1
(43) Pub. Date: Apr. 17, 2003

(54) Battery enclosing encryption key

(76) Inventor: Katsutoshi Hayashi, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/237,621

(22) Filed: Sep. 10, 2002

(30) Foreign Application Priority Data
Oct. 15, 2001 (JP) 2001-316805

(51) Int. Cl. H04L 9/32

(52) U.S. Cl. 713/193

(57) ABSTRACT

A battery comprises: a charged portion in which electric charges are accumulated; a record medium; an encryption key which is stored in the record medium; a control circuit which reads the encryption key from the record medium; a case which encloses the charged portion, the record medium and the control circuit. The control circuit operates only when the charged portion is charged with charges more than a predetermined value, and the encryption key is read from the record medium by the control circuit only when the charged portion is charged with charges more than the predetermined value. A shape of the case is unique to an apparatus to which a power is supplied from the battery.

### BACKGROUND OF THE INVENTION

1. Field of the Invention

The present invention relates to a battery which encloses a encryption key and is used for an apparatus such as a handheld terminal.

2. Description of the Related Art

In a conventional handheld terminal, a private key used for a common key system or a private key used for a public key system is stored in a PCMCIA (Personal Computer Memory Card International Association) card or a memory enclosed in the handheld terminal. Hereinafter, we use a word of “a private key” for both that used for a common key system and that used for a public key system.

However, there has been a risk that a PCMCIA card is disconnected from a handheld terminal and a private key is read from the PCMCIA and analyzed using a personal computer because the personal computer has a function of reading the contents of a PCMCIA card connected to a slot of the personal computer. In addition, in both of a system in which a private key is stored in a PCMCIA card and a system in which a private key is stored in a memory enclosed in a handheld terminal, there has been a risk that encrypted data which is stored in a handheld terminal is decoded using the private key which has been read in the above manner.

### SUMMARY OF THE INVENTION

An object of the present invention is to provide a battery enclosing a private key which minimizes a risk that the private key is analyzed and a risk that encrypted data held in an equipment is decrypted using the private key.

According to a first aspect of the present invention, there is provided a battery comprising: a charged portion in which electric charges are accumulated; a record medium; an encryption key which is stored in the record medium; a control circuit which reads the encryption key from the record medium; a case which encloses the charged portion, the record medium and the control circuit.

In the battery, the control circuit may operate only when the charged portion is charged with charges more than a predetermined value, and the encryption key may be read from the record medium by the control circuit only when the charged portion is charged with charges more than the predetermined value.

In the battery, a shape of the case may be unique to an apparatus to which a power is supplied from the battery.

In the battery, the encryption key may be a private key of a common key system.

In the battery, the encryption key may be a private key of a private key system.

According to a second aspect of the present invention, there is provided an apparatus to which a power is supplied from the battery according to the first aspect, comprising: means for reading the encryption key from the battery; and means for decrypting plaintext data using the encryption key.

According to a third aspect of the present invention, there is provided an apparatus to which a power is supplied from the battery according to the first aspect, comprising: a button group; detecting means for detecting a specific operation to the button group; and means for reading the encryption key from the battery only when the detecting means detects the specific operation.

These and other objects, features and advantages of the present invention will become more apparent in the light of the following detailed description of the best mode embodiments thereof, as illustrated in the accompanying drawings.

### BRIEF DESCRIPTION OF THE DRAWINGS

FIG. 1 is a block diagram showing a structure of a battery according to an embodiment of the present invention;

FIG. 2 is a block diagram showing parts of a handheld terminal and the battery relating to encryption according to the embodiment of the present invention;

FIG. 3 is a block diagram showing a structure of the handheld terminal according to the embodiment of the present invention;

FIG. 4 is a schematic diagram showing a console of the handheld terminal according to the embodiment of the present invention;

FIG. 5 is another block diagram showing parts of a handheld terminal and the battery relating to encryption according to the embodiment of the present invention;

FIG. 6 is a perspective view of a personal computer and a battery according to the embodiment of the present invention;

FIG. 7 is a perspective view of a portable telephone and a battery according to the embodiment of the present invention; and

FIG. 8 is a perspective view of a PDA and a battery according to the embodiment of the present invention.

### DETAILED DESCRIPTION OF THE PREFERRED EMBODIMENT

Preferred embodiments according to the present invention will be described with reference to the accompanying drawings.

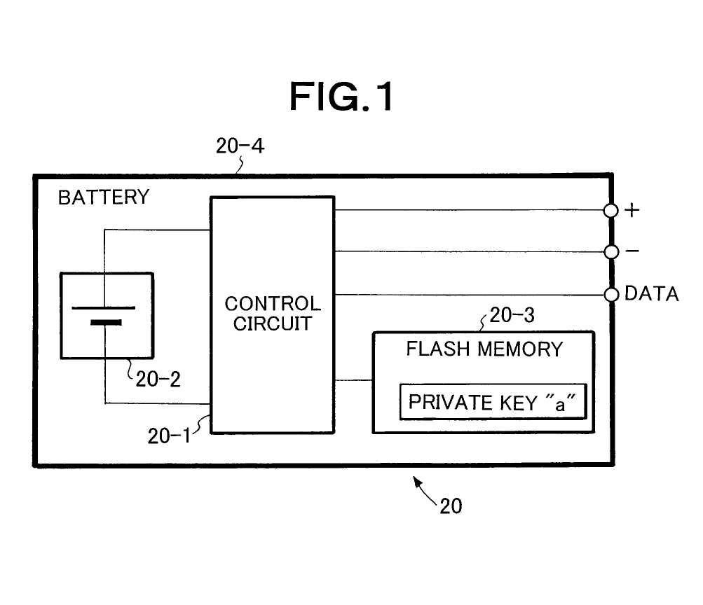

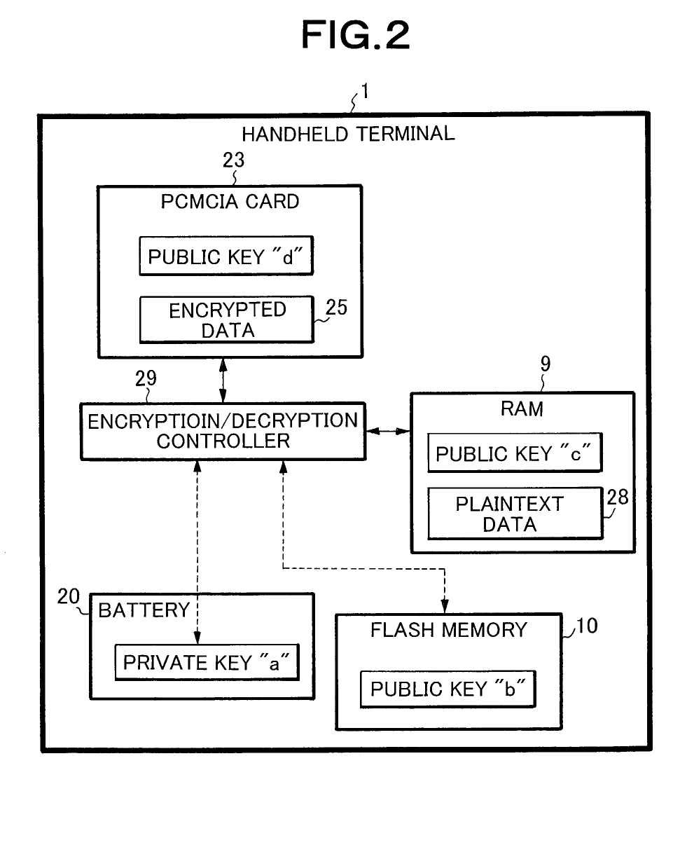

In the present invention, any one of a common key system and a public key system is used as an encryption system. A private key is stored in a record medium such as a flash memory 20-3 (FIG. 1), an EEPROM (Electrically Erasable and Programmable Read Only Memory), and an FRAM (Ferroelectric Random Access Memory) which is enclosed in a battery 20 which will be attached to a handheld terminal 1 as shown in FIG. 2. Referring to FIG. 2, in a case where a common key system is used and the battery 20 is attached to the handheld terminal 11, the private key “a” is transferred from the battery 20 to the handheld terminal 1 and plaintext data which is temporarily stored in a RAM 9 is encrypted into encrypted data 25 to be stored in the PCMCIA card 23 using the transferred private key “a” or the encrypted data 25 stored in the PCMCIA card 23 is decrypted to the plaintext data to be temporarily stored in the RAM 9 using the transferred private key “a”. In a case where a public key system is used, plaintext data which is temporarily stored in the RAM 9 is encrypted into encrypted data to be stored in the PCMCIA card 23 using a public key “b” stored in a flash memory 10, a public key “c” stored in the RAM 9 or a public key “d” stored in the PCMCIA card 23 regardless of whether or not the battery is attached to the handheld terminal 1. In a case where a public key system is used and the battery 20 is attached to the handheld terminal 11, the private key “a” is transferred from the battery 20 to the handheld terminal 1 and the encrypted data 25 stored in the PCMCIA card 23 is decrypted to the plaintext data to be temporarily stored in the RAM 9 using the transferred private key “a”.

Referring to FIG. 1, in a record medium such as a flash memory 20-3 of the battery 20, there is conventionally a file area provided for storing management information which is use for managing a lifetime of the battery 20 in terms of the number of cycles of charging/discharging. According to the present invention, there is also a private key area for storing a private key in the record medium of the battery 20, whereby the battery according to the present invention is compatible with the conventional battery. Unlike a PCMCIA card, the battery 20 does not have a versatile interface and is attachable to the specific handheld terminal 1 which has a unique interface with the battery 20. In addition, unlike a dry battery, the shape of the battery 20 is not versatile and is unique to the handheld terminal 1. Therefore, a risk that the private key within the battery 20 is analyzed is minimized. Further, because a control circuit 20-1 of the battery 20 operates only when the battery is charged, there is another advantage that the private key “a” is readable through the control circuit 20-1 only when the battery is charged.

A dedicated software is used for writing the private key “a” to the flash memory 20-3. The dedicated software runs on a dedicated handheld terminal which has the same shape as a normal handheld terminal. Alternatively, the dedicated software runs on a dedicated handheld terminal which has a specific shape.

Referring to FIG. 1, the battery according to the preferred embodiment of the present invention comprises: a charged portion 20-2 in which electric charges are accumulated; the control circuit 20-1 which charges the charged portion 20-2 in response to a signal from the handheld terminal 1 and writes/reads the contexts including the number of cycles of charging/discharging and the private key “a” to/from the flash memory 20-3; and the flash memory 20-3 which stores the contexts including the number of cycles of charging/discharging and the private key “a”. The charged portion 20-2, the control circuit 20-1 and the flash memory 20-3 are completely enclosed in a case 20-4 of the battery 20. The shape of the case 20-4 of the battery 20 is designed so that the battery mechanically fits the concave for the battery 20 of the handheld terminal 1. The shape of the case of the battery 20 is determined by the unique shape of the concave for the battery 20 of the handheld terminal 1.

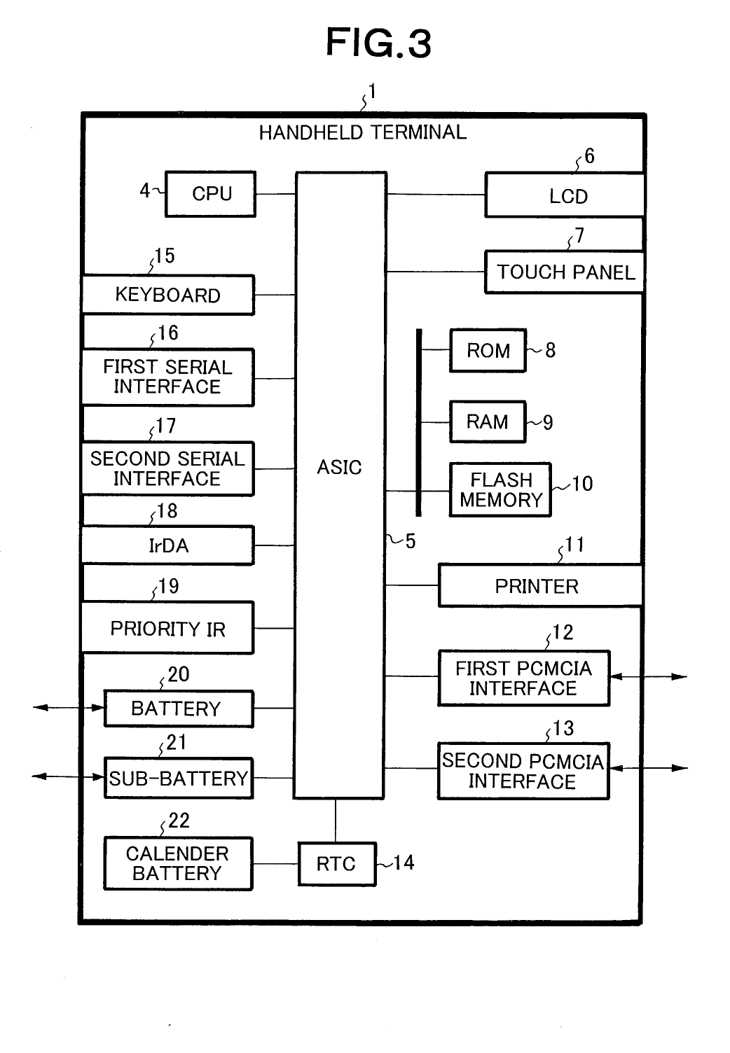

Referring to FIG. 3, the handheld terminal 1 comprises: a first PCMCIA interface 12 and a second PCMCIA interface 13 which exchange data with another handheld terminal using a PCMCIA card; a first serial interface 16 and a second serial interface 17 which exchange data with a host computer such as a personal computer; and an infrared ray interface 18 compliant to an IrDA (Infrared Data Association) standard an infrared ray interface 19 compliant to an original specification which exchange data with a host computer. The handheld terminal 1 further comprises: a CPU (Central Processing Unit) 4 and ASIC (Application Specific Integrated Circuit) (not shown) which controll the whole operation of the handheld terminal 1; a LCD (Liquid Crystal Display) 6 which displays characters and so forth; a touch panel 7 which detects touching a finger to a character on the LCD 6; a ROM (Read Only Memory) 8 which stores a program for controlling the operation of the CPU 4; a RAM (Random Access Memory) 9 which temporarily stores data; a flash memory 10 which consecutively stores written data and is rewritable; a printer 11; an RTC (Real Time Clock) 14 which counts the data and time; a key board 15; and a calendar battery 22 which is a power source of the RTC 14. The battery 20 and a sub-battery 21 are attached to the handheld terminal 1.

A Data file is not encrypted when it is temporarily stored in the RAM 9. However, it is necessary that the data file is encrypted when it is stored in any one of the flash memory 10 and the PCMCIA card 23.

In addition, it is necessary that data is encrypted when the data is exchanged with a host computer via any one of the serial interface 16 and 17, and the infrared interface 18 and 19.

In a case where a common key system is used and data is transferred from a host computer to the handheld terminal 1, the transferred data is encrypted using a private key stored in the host computer before the transmission and the transferred data is decrypted using the private key “a” stored in the battery 20 after the transmission. The security of the private key stored in the host computer is a matter of management. However, it is assumed that the host computer has a function for keeping the security.

In a case where a public key system is used and data is transferred from a host computer to the handheld terminal 1, the transferred data is encrypted using a public key stored in the host computer before the transmission and the transferred data is decrypted using the private key “a” stored in the battery 20 after the transmission. The security of the public key in the host computer is unnecessary.

In a case where a common key system is used and data is transferred from the handheld terminal 1 to a host computer, the transferred data is encrypted using the private key “a” stored in the battery 20 before transmission and the transferred data is decrypted using a private key stored in the host computer. The security of the private key stored in the host computer is a matter of management. However, it is assumed that the host computer has a function for keeping the security.

In a case where a public key system is used and data is transferred from the handheld terminal 1 to a host computer, the transferred data is encrypted using any one of the public key “b” stored in the flash memory 10, the public key “c” stored in the RAM 9 and the public key “d” stored in the PCMCIA card 23. The security of the private key stored in the host computer is a matter of management. However, it is assumed that the host computer has a function for keeping the security.

Referring to FIG. 2, a private key is required when an encryption/decryption controller 29 decrypts the encrypted data 25 stored in the PCMCIA card 23. The encryption/decryption controller 29 is embodied by the CPU 4 and the program stored in the ROM 8. According to the present invention, the private key “a” stored in the battery 20 is used as the private key for the decryption. Alternatively, a private key which is generated from a combination of the private key “a” stored in the battery 20 and at least one of the public key “b”, “c” and “d” may be used as the private key for the decryption. Because of such operation, the plaintext data 28 only temporarily exists in the RAM 9 and is not read externally.

Referring to FIG. 1, the control circuit 20-1 is operatable only when charged portion 20-2 is charged with charges more than a predetermined value, and is not operatable otherwise. Therefore, it is not possible to read the private key “a” and to decrypt encrypted data when the charged portion 20-2 is not charged with charges more than the predetermined value, whereby it becomes more difficult to decrypt the encrypted data.

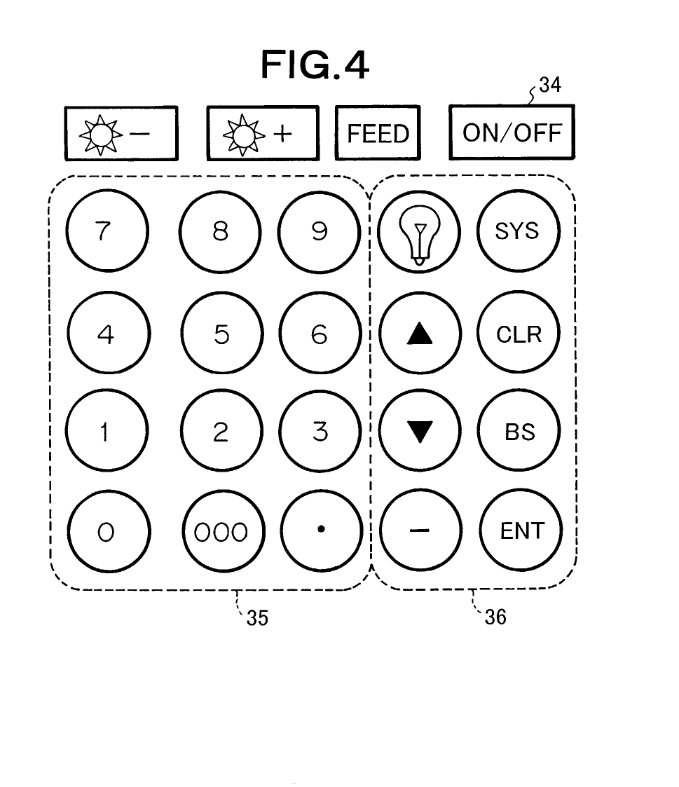

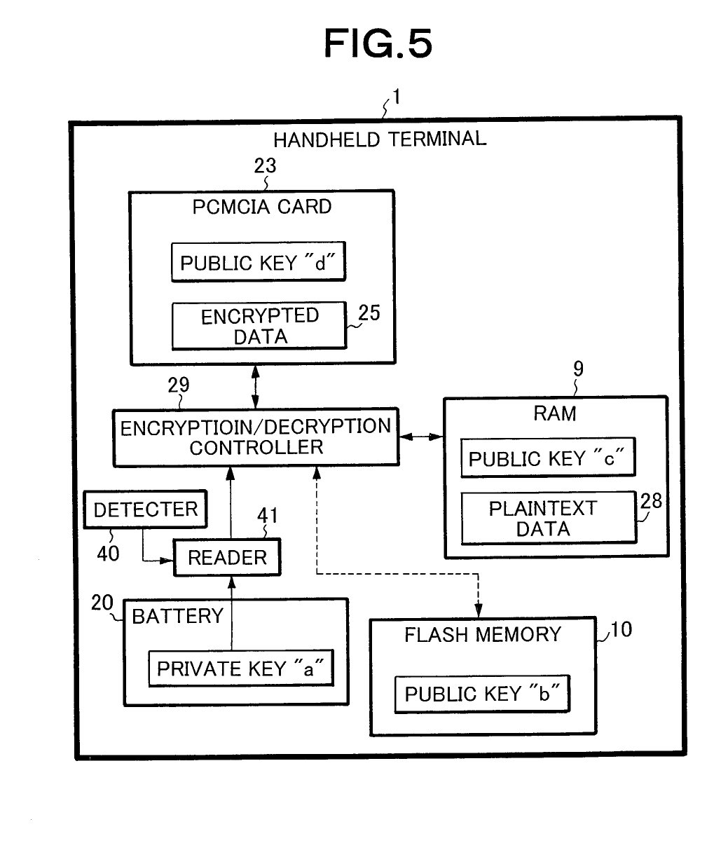

Referring to FIG. 4, in order to operate the handheld terminal 1, it is necessary to attach the battery 20 to the handheld terminal 1 and turns on the power of the hand held terminal 20. The turning on the power is executed by pressing a power button (ON/OFF button) 34. Only if the power button 34 is pressed simultaneously with a certain key of a numeric keypad 35 or a certain key of function key group 36, the private key 36 stored in the battery 20 may be accessed. Alternatively, only if a password is entered using the numeric keypad 35, the private key 36 stored in the battery 20 may be accessed. By using these feature, it becomes more difficult to decrypt the encrypted data. In order to realize these features, the handheld terminal 1 comprises a detector 40 for detecting the simultaneous key pressing or an input of the password and a reader 41 for reading the private key “a” from the battery 20 only when activated by the detector as shown in FIG. 5. The detector 40 and the reader 41 are embodied by the CPU 4 and the program stored in the ROM 8.

As a power source which is used for supplying the power to the handheld terminal 1 and stores the private key “a”, an AC power adapter and a car battery adapter may be used as well as the battery 20.

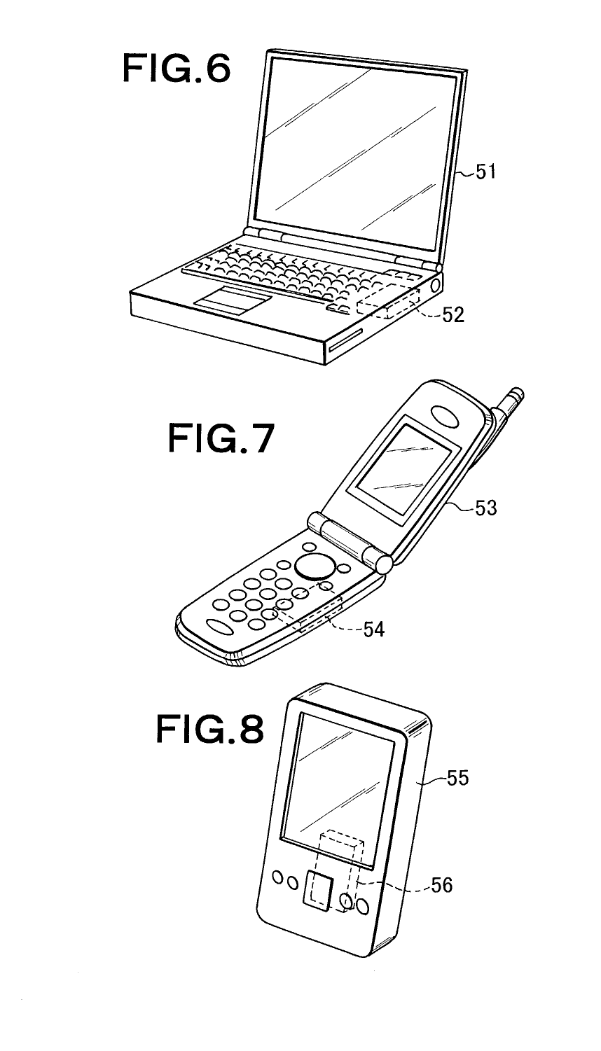

In the above embodiment, the combination of the handheld terminal 1 and the battery 20 enclosing the private key “a” was explained. However, the present invention is not limited to such combination. Other embodiments of the present invention include a combination of a personal computer 51 and a battery which supplies a power to the personal computer 51 and encloses a private key 52 (FIG. 6), a combination of a portable telephone 53 and a battery 54 which supplies a power to the portable telephone 53 and encloses a private key (FIG. 7), and a combination of a PDA (Personal Digital Assistant) 55 and a battery 56 which supplies a power to the PDA 55 and encloses a private key (FIG. 8). The batteries 52, 54 and 56 have the similar structure to the battery 20-4.

Although the present invention has been shown and explained with respect to the best mode embodiments thereof, it should be understood by those skilled in the art that the foregoing and various other changes, omissions, and additions in the form and detail thereof may be made therein without departing from the spirit and scope of the present invention.

What is claimed is:

1. A battery comprising:
a charged portion in which electric charges are accumulated;
a record medium;
an encryption key which is stored in said record medium;
a control circuit which reads said encryption key from said record medium;
a case which encloses said charged portion, said record medium and said control circuit.

2. The battery as set forth in claim 1,
wherein said control circuit operates only when said charged portion is charged with charges more than a predetermined value, and
wherein said encryption key is read from said record medium by said control circuit only when said charged portion is charged with charges more than said predetermined value.

3. The battery as set forth in claim 1,
wherein a shape of said case is unique to an apparatus to which a power is supplied from the battery.

4. The battery as set forth in claim 1,
wherein said encryption key is a private key of a common key system.

5. The battery as set forth in claim 1,
wherein said encryption key is a private key of a private key system.

6. An apparatus to which a power is supplied from the battery as set forth in claim 1, comprising:
means for reading said encryption key from the battery; and
means for decrypting plaintext data using said encryption key.

7. An apparatus to which a power is supplied from the battery as set forth in claim 1, comprising:
a button group;
detecting means for detecting a specific operation to said button group; and
means for reading said encryption key from the battery only when said detecting means detects the specific operation.
